(19) United States
(12) Patent Application Publication
(10) Pub. No.: US 2023/0394363 A1
(43) Pub. Date: Dec. 7, 2023

(54) BEHAVIOR PREDICTION METHOD, BEHAVIOR PREDICTION APPARATUS AND PROGRAM

(71) Applicant: NIPPON TELEGRAPH AND TELEPHONE CORPORATION, Tokyo (JP)

(72) Inventors: Takeshi KURASHIMA; Hiroyuki TODA

(21) Appl. No.: 18/250,089

(22) PCT Filed: Dec. 3, 2020
(86) PCT No.: PCT/JP2020/045032

§ 371 Date: Apr. 21, 2023

(51) Int. Cl. G06N 20/00

(52) U.S. Cl. CPC G06N 20/00

(57) ABSTRACT

A computer evaluates, from a first behavior history including, for each of a plurality of behaviors of a person, a time of the behavior and a numerical value indicating the person's state after the behavior, a first feature indicating a first amount of effort the person makes until the numerical value exceeds a threshold at a certain point in time; evaluates, from the first behavior history, a second feature indicating a degree of the person's habituation to a state indicated by the threshold by the certain point in time; and trains a prediction model, in which the first and second features are used as explanatory variables and a time interval from a behavior at the certain point in time to a next behavior in the first behavior history is used as an explained variable, based on the first and second features and the time interval.

### TECHNICAL FIELD

The present invention relates to a behavior prediction method, a behavior prediction apparatus, and a program.

### BACKGROUND ART

Conventionally, there is a method of predicting the time at which a person will start the next behavior by using a deep learning technique based on past history information related to the person. For example, by using a recurrent neural network such as a long short-term memory (LSTM) specialized for handling time-series data, the regularity or pattern existing in time-series data can be automatically extracted, and the time at which the next behavior will occur can be predicted (see, for example, Non-Patent Literature 1).

### CITATION LIST

### Non-Patent Literature

Non-Patent Literature 1: Hochreiter, Sepp and Schmidhuber, Jurgen. “Long short-term memory.” Neural computation 9.8 (1997): 1735-1780.

### SUMMARY OF INVENTION

### Technical Problem

However, in the related art, regularity or a pattern is automatically extracted and learned from past history information related to a person. That is, in the related art, a process for finding out what feature should be emphasized and what mathematical expression should be used for prediction from among an infinite number of possibilities is performed. Therefore, it is necessary to prepare a large amount of data to apply the related art, and so it is difficult to perform accurate prediction in a situation where a large amount of data cannot be prepared.

In addition, in the related art, even in a situation where a large amount of data exists, it is necessary to manually set a numerical value (for example, the number of layers in deep learning, the number of nodes (neurons) in each layer, and the like) called a hyperparameter, and it is necessary to spend significant time for tuning.

The present invention has been made in view of the above, and an object thereof is to make possible efficient behavior prediction.

### Solution to Problem

Therefore, in order to solve the above problem, a computer executes: a first evaluation procedure of evaluating, from a first behavior history including, for each of a plurality of behaviors of a certain person, a time of the behavior and a numerical value indicating a state of the certain person after the behavior, a first feature indicating an amount of effort the certain person makes until the numerical value exceeds a threshold at a certain point in time; a second evaluation procedure of evaluating, from the first behavior history, a second feature indicating a degree of habituation of the certain person to a state indicated by the threshold by the certain point in time; and a learning procedure of training a prediction model, in which the first feature and the second feature are used as explanatory variables and a time interval from a behavior at a certain point in time to a next behavior in the first behavior history is used as an explained variable, based on the first feature, the second feature, and the time interval.

### Advantageous Effects of Invention

Efficient behavior prediction is made possible.

### BRIEF DESCRIPTION OF DRAWINGS

FIG. 1 is a diagram illustrating a hardware configuration example of a behavior prediction apparatus 10 according to an embodiment of the present invention;

FIG. 2 is a diagram illustrating a functional configuration example of the behavior prediction apparatus 10 according to the embodiment of the present invention; and

FIG. 3 is a diagram for describing processing executed by each of an effort evaluation unit 13 and a habituation evaluation unit 14.

### DESCRIPTION OF EMBODIMENTS

In the present embodiment, there is disclosed a behavior prediction apparatus 10 that predicts, from a behavior history, the time at which a person given a rating indicating the status (state) of the person will start the next behavior in a situation in which the rating of the person changes stochastically according to the result of a certain behavior (for example, the person can participate in some game, and the rating indicating the person's gaming skill changes according to the result of the game). In addition, a situation is assumed in which some reference score exists regarding rating (for example, a situation in which a certain title is given when the rating of the person is a certain value or more).

Note that “rating” is a generic term that means a numerical value of the status of a person in a broad sense, such as the evaluation score of the person, the amount of money in possession, and the like. The operation of the present embodiment will be described assuming that a higher rating indicates a better evaluation, but the present embodiment may operate by reversing this assumption as well.

In addition, “reference score” is a generic term that means a numerical value that is used as a reference when a person determines a value, such as a rounded value in rating (such as a numerical value that can be divided by 100), the maximum value (minimum value) of rating recorded by the person himself/herself in the past, and the rating value that serves as a boundary (stage) at which a title is given.

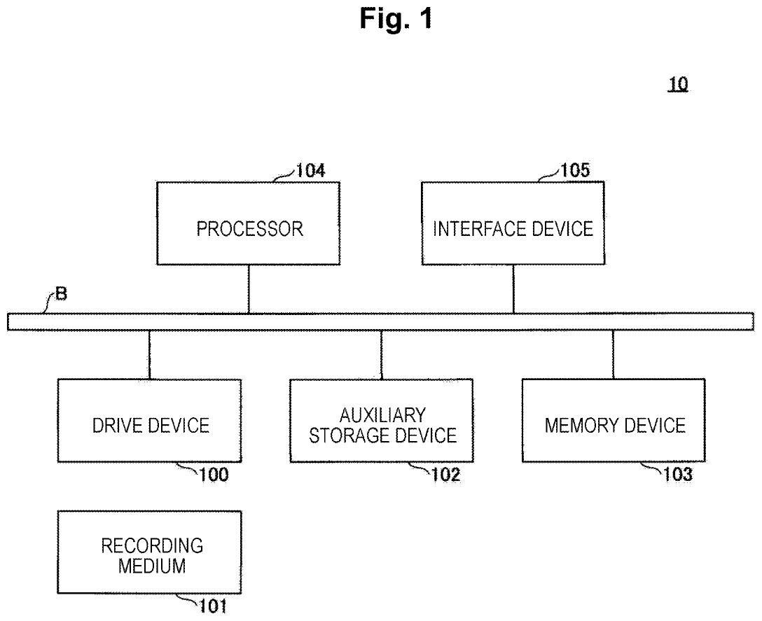

Hereinafter, an embodiment of the present invention will be described with reference to the drawings. FIG. 1 is a diagram illustrating a hardware configuration example of a behavior prediction apparatus 10 according to an embodiment of the present invention. The behavior prediction apparatus 10 in FIG. 1 includes a drive device 100, an auxiliary storage device 102, a memory device 103, a processor 104, an interface device 105, and the like which are connected to each other via a bus B.

A program for implementing processing in the behavior prediction apparatus 10 is provided by a recording medium 101 such as a CD-ROM. When the recording medium 101 storing the program is set in the drive device 100, the program is installed in the auxiliary storage device 102 from the recording medium 101 via the drive device 100. However, the program is not necessarily installed from the recording medium 101, and may be downloaded from another computer via a network. The auxiliary storage device 102 stores the installed program and also stores necessary files, data, and the like.

In a case where there is an instruction to start the program, the memory device 103 reads and stores the program from the auxiliary storage device 102. The processor 104 is a CPU or a graphics processing unit (CPU), or a CPU and GPU, and executes a function related to the behavior prediction apparatus 10 according to the program stored in the memory device 103. The interface device 105 is used as an interface for connecting to a network.

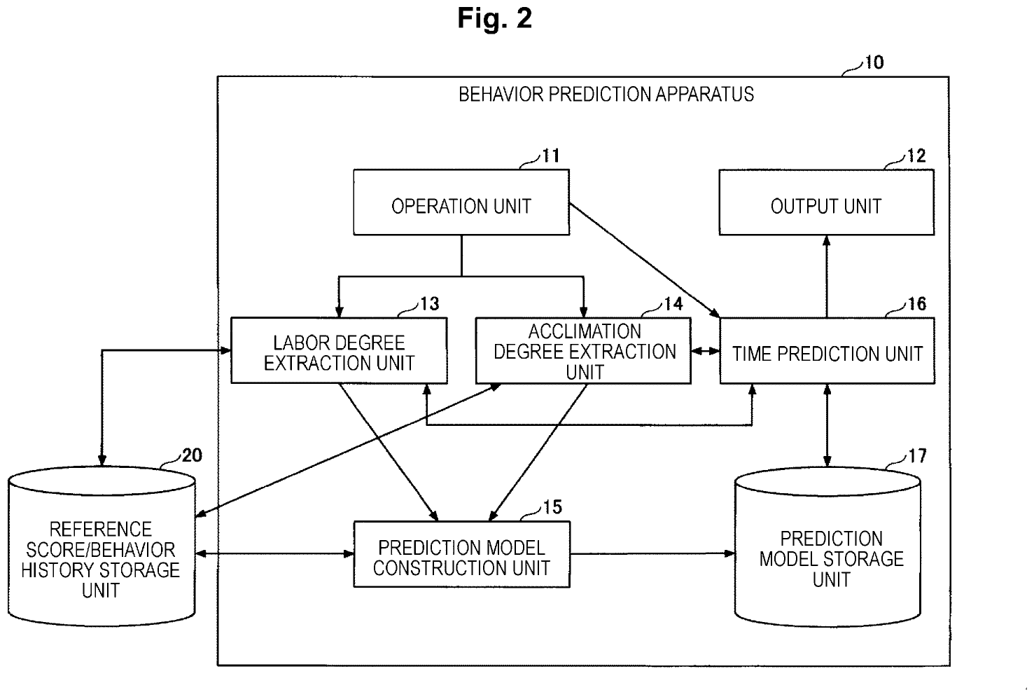

FIG. 2 is a diagram illustrating a functional configuration example of the behavior prediction apparatus 10 according to the embodiment of the present invention. In FIG. 2, the behavior prediction apparatus 10 includes an operation unit 11, an output unit 12, an effort evaluation unit 13, a habituation evaluation unit 14, a prediction model construction unit 15, and a time prediction unit 16. Each of these units is implemented by processing executed by the processor 104 by one or more programs installed in the behavior prediction apparatus 10. The behavior prediction apparatus 10 also uses a prediction model storage unit 17. The prediction model storage unit 17 can be implemented using, for example, the auxiliary storage device 102, a storage device connectable to the behavior prediction apparatus 10 via a network, or the like. Note that, among the components of the behavior prediction apparatus 10, the effort evaluation unit 13, the habituation evaluation unit 14, and the prediction model construction unit 15 are connected to an external reference score/behavior history storage unit 20. In FIG. 2, the reference score/behavior history storage unit 20 is illustrated outside the behavior prediction apparatus 10, but the behavior prediction apparatus 10 may include the reference score/behavior history storage unit 20.

The reference score/behavior history storage unit 20 stores information indicating a reference score (reference score information) and behavior history information of each of a plurality of persons. The reference score/behavior history storage unit 20 reads the reference score information and the behavior history information of the person in accordance with a request from the behavior prediction apparatus 10, and transmits this information to the behavior prediction apparatus 10. A reference score of M points can be expressed as R=<r₁, r₂, . . . r_{N}>. It is assumed that r is a numerical value indicating a specific rating and is sorted in ascending numerical order (rᵢ<rᵢ₊₁).

The behavior history information of the person u can be expressed as Hu={(sᵤ₁,tᵤ₁), . . . , (sᵤₙ,tᵤₙ)}. Each element of the behavior history information indicates a behavior event, where t indicates the time (timing such as time) when the behavior is started, and s indicates the rating of the person after the behavior is started. The reference score/behavior history storage unit 20 stores such behavior history information related to a plurality of persons.

The operation unit 11 receives an operation related to execution of prediction model construction from a user of the behavior prediction apparatus 10. When such an operation is received, the operation unit 11 transmits an execution command related to construction of the prediction model to the effort evaluation unit 13 and the habituation evaluation unit 14. Upon receiving the behavior history information of the person (prediction target person) for whom the prediction is to be performed (the form of the behavior history information is as described above), the operation unit 11 transmits the behavior history information to the time prediction unit 16. The hardware for the operation unit 11 to receive an input is not limited to predetermined hardware such as a keyboard, a mouse, a menu screen, and a touch panel. The operation unit 11 is implemented by, for example, processing executed by the processor 104 by a device driver of input means such as a mouse or control software of a menu screen.

The output unit 12 receives and outputs the prediction result transmitted from the time prediction unit 16. Here, the concept of output includes displaying on a display, printing on a printer, sound output, transmission to an external device, and the like. The output unit 12 is implemented by, for example, processing executed by the processor 104 by the driver software of the output device or the driver software of the output device and the output device.

When a person exceeds a certain reference score rᵢ (in a positive direction) at a certain point in time due to a change in rating caused by a certain behavior event, the effort evaluation unit 13 evaluates, from the behavior history information and the reference score information of the person, a feature indicating the amount of effort the person makes (how much effort the person makes) (hereinafter the amount of effort is referred to as a “effort amount”) as of exceeding the previous reference score rᵢ₋₁, until exceeding the next reference score rᵢ. For example, the effort evaluation unit 13 evaluates, as the effort amount, the value obtained by quantifying how many times a certain person performs a behavior event as of exceeding the previous reference score rᵢ₋₁ until exceeding the next reference score rᵢ, or how much time it takes (the time elapsed as of exceeding the reference score rᵢ₋₁ until exceeding the reference score rᵢ), based on the behavior history information and the reference score information of the person. The effort evaluation unit 13 transmits the feature as the evaluated effort amount to the prediction model construction unit 15.

When a person exceeds a certain reference score rᵢ (in a positive direction) at a certain point in time due to a change in rating caused by a certain behavior event, the habituation evaluation unit 14 evaluates, from the behavior history information and the reference score information of the person, a feature indicating how many times the person has exceeded the reference score rᵢ (in a positive direction) in the past (a feature indicating the degree (or level) of habituation of the person to the reference score rᵢ) (hereinafter the degree of habituation is referred to as an “habituation degree”). The habituation evaluation unit 14 transmits the feature, as the evaluated habituation degree, to the prediction model construction unit 15.

The prediction model construction unit 15 constructs (trains) a prediction model that predicts time information for the person to start the next behavior based on the information related to the person and the behavior history of the person. The information related to the person is a basic feature (the average value of time intervals between behavior events for each person, the average rating value of each person, and the like) calculated from the behavior history information transmitted from the reference score/behavior history storage unit 20. The prediction model construction unit 15 further uses the effort amount and the habituation degree transmitted from the effort evaluation unit 13 or the habituation evaluation unit 14 as information related to the person. The machine learning device used for parameter estimation of the prediction model may be any supervised learning device such as a regression tree. Various types of information (for example, parameters of the prediction model, and the like) related to the prediction model constructed by the prediction model construction unit 15 are transmitted to the prediction model storage unit 17. Note that the prediction model is common to a plurality of persons. That is, the prediction model construction unit 15 trains the prediction model using the information related to the plurality of persons and the behavior histories of the plurality of persons as training data.

The prediction model storage unit 17 stores various types of information related to the prediction model transmitted from the prediction model construction unit 15. The prediction model storage unit 17 may be anything as long as the information can be stored and restored. For example, the information is stored in a database or a specific area of a general-purpose storage device (memory or hard disk device) provided in advance.

The time prediction unit 16 receives the prediction target behavior history information, which is the behavior history information of the prediction target person transmitted from the operation unit 11, sets the basic feature (the average value of time intervals between behavior events for the person, the average rating value of the person, and the like) calculated from the prediction target behavior history information, and the effort amount and the habituation degree calculated by the effort evaluation unit 13 or the habituation evaluation unit 14 from the prediction target behavior history information as information related to the person, and calculates a prediction value of time information (timing such as time) when the prediction target person will start the next behavior using the information and the prediction model stored in the prediction model storage unit 17 (applying the prediction model to the information).

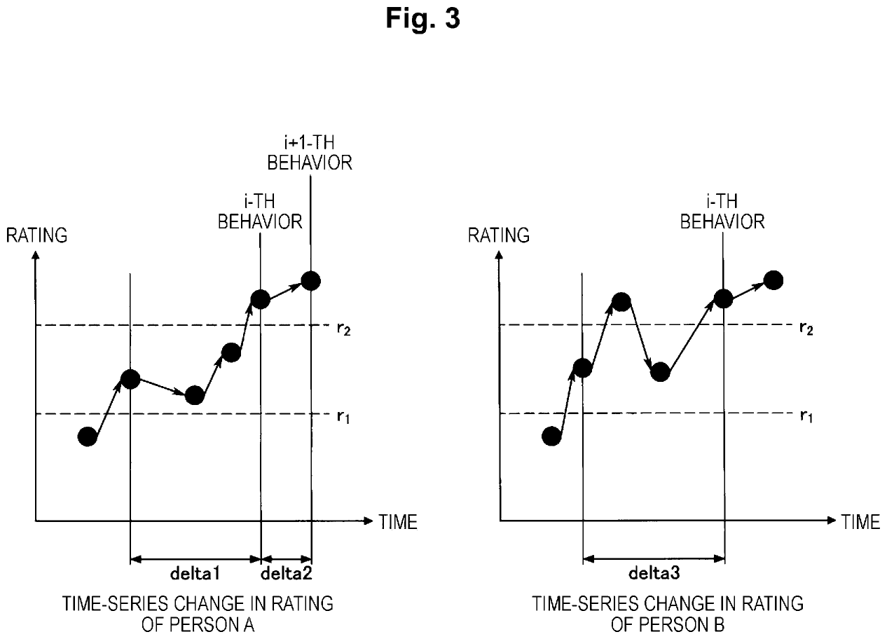

Hereinafter, processing executed by each of the effort evaluation unit 13 and the habituation evaluation unit 14 will be described using a specific example. FIG. 3 is a diagram for describing processing executed by each of the effort evaluation unit 13 and the habituation evaluation unit 14. FIG. 3 illustrates changes in the rating of two persons (person A and person B) over time. The horizontal axis represents time, the vertical axis represents rating, and the black circles represent each behavior event. Ratings r₁ and r₂ serving as reference scores are indicated by dotted lines.

For the i-th behavior event (as a result of which the rating r₂ is exceeded) of the person A on the left side in FIG. 3, since the person A undergoes behavior events three times as of the previous rating r₁ being exceeded, the effort evaluation unit 13 evaluates these three times as the effort amount. Alternatively, the effort evaluation unit 13 may evaluate a time interval delta 1 as the effort amount. Since it is the first time that the person A experiences exceeding the rating r₂ as a result of the rating increase, the habituation evaluation unit 14 evaluates 1 as the habituation degree.

On the other hand, for the person B on the right side in FIG. 3, the effort evaluation unit 13 evaluates three times or delta 3 as the effort amount. Since the experience of exceeding the rating r₂ in the positive direction is at the second time, the habituation evaluation 14 evaluates 2 as the habituation degree of the person B. As for the method of counting the effort of the person B, with exclusion of the case where the rating r₂ is exceeded for the first time, the number of times the rating between r₁ and r₂ is recorded as of r₁ being exceeded may be counted as two times. In addition, the count may be cleared at the timing of the case where the rating r₂ is exceeded for the first time, and then the number of times of rating between r₁ and r₂ (once) may be used.

In the case of the person A, the prediction model construction unit 15 generates a combination of data in which the effort amount (three times or delta 1), the habituation degree (one time), and the basic feature of the person A (the average value of time intervals for the person A until the i-th behavior event, the average rating value of the person A up to the i-th behavior event, and the like) are used as explanatory variables and delta 2, which is the time interval until the i+1-th behavior event, is used as an explained variable, and constructs (trains) the prediction model using the supervised learning technology based on this data. Similarly, the prediction model construction unit 15 trains the prediction model based on the information related to the person B. Such a prediction model can be used, for example, to predict the next behavior of a person C (here, it may be used for the next prediction of the person A or the person B).

As described above, according to the present embodiment, it is possible to efficiently reduce the matters to be learned from data for prediction by explicitly designating features and features that are important in predicting human behavior, and by appropriately narrowing down an infinite number of possibilities regarding what feature should be emphasized and what mathematical expression should be used for prediction. Therefore, even in a case where only a small amount of data exists, highly accurate prediction can be performed. In addition, the cost of parameter tuning required in the related art can be reduced. Therefore, efficient behavior prediction is made possible.

Note that, in the present embodiment, the effort amount is an example of a first feature. The habituation degree is an example of a second feature. The effort evaluation unit 13 is an example of a first evaluation unit. The habituation evaluation unit 14 is an example of a second evaluation unit. The prediction model construction unit 15 is an example of a learning unit. The time prediction unit 16 is an example of a prediction unit. The reference score is an example of a threshold.

Although the embodiment of the present invention has been described in detail above, the present invention is not limited to such a specific embodiment, and various modifications and changes can be made within the scope of the gist of the present invention described in the claims.

### REFERENCE SIGNS LIST

10 Behavior prediction apparatus

11 Operation unit

12 Output unit

13 Effort evaluation unit

14 Habituation evaluation unit

15 Prediction model construction unit

16 Time prediction unit

17 Prediction model storage unit

20 Reference score/behavior history storage unit

100 Drive device

101 Recording medium

102 Auxiliary storage device

103 Memory device

104 Processor

105 Interface device

B Bus

1. A behavior prediction method executed by a computer, the method comprising:
evaluating, from a first behavior history including, for each of a plurality of behaviors of a person, a time of the behavior and a numerical value indicating a state of the person after the behavior, a first feature indicating a first amount of effort the person makes until the numerical value exceeds a threshold at a certain point in time;
evaluating, from the first behavior history, a second feature indicating a degree of habituation of the person to a state indicated by the threshold by the certain point in time; and
training a prediction model, in which the first feature and the second feature are used as explanatory variables and a time interval from a behavior at the certain point in time to a next behavior in the first behavior history is used as an explained variable, based on the first feature, the second feature, and the time interval.

2. The behavior prediction method according to claim 1,
wherein the threshold has a plurality of stages,
wherein the first feature further indicates a second amount of effort the person makes from a point in time at which a second stage, which is one stage lower than a first stage exceeded at the certain point in time, is exceeded up to a point in time at which the first stage is exceeded, and
wherein the second feature amount further indicates a degree of habituation of the person to the first stage by the certain point in time.

3. The behavior prediction method executed by a computer according to claim 1, further comprising
predicting a time of a next behavior in a second behavior history by using the prediction model.

4. A behavior prediction apparatus comprising:
a processor; and
a memory storing executable instructions which, when executed by the processor, cause the processor to:
evaluate, from a first behavior history including, for each of a plurality of behaviors of a person, a time of the behavior and a numerical value indicating a state of the person after the behavior, a first feature indicating a first amount of effort the person makes until the numerical value exceeds a threshold at a certain point in time;
evaluate, from the first behavior history, a second feature indicating a degree of habituation of the person to a state indicated by the threshold by the certain point in time; and
train a prediction model, in which the first feature and the second feature are used as explanatory variables and a time interval from a behavior at the certain point in time to a next behavior in the first behavior history is used as an explained variable, based on the first feature, the second feature, and the time interval.

5. The behavior prediction apparatus according to claim 4,
wherein the threshold has a plurality of stages,
wherein the first feature further indicates a second amount of effort the person makes from a point in time at which a second stage, which is one stage lower than a first stage exceeded at the certain point in time, is exceeded up to a point in time at which the first stage is exceeded, and
wherein the second feature further indicates a degree of habituation of the person to the first stage by the certain point in time.

6. The behavior prediction apparatus according to claim 4,
wherein the processor is further configured to predict a time of a next behavior in a second behavior history by using the prediction model.

7. A non-transitory computer-readable recording medium storing a program that causes a computer to execute the behavior prediction method according to claim 1.
